(19) United States
(12) Patent Application Publication
(10) Pub. No.: US 2003/0135556 A1
(43) Pub. Date: Jul. 17, 2003

(54) Selection of communication strategies for message brokers or publish/subscribe communications

(75) Inventor: Simon A. J. Holdsworth, Andover (GB)

Correspondence Address: A. Bruce Clay, IBM Corp, IP Law Dept T81/503, 3039 Cornwallis Road, PO Box 12195, Research Triangle Park, NC, 27709-2195, US

(73) Assignee: International Business Machines Corporation, Armonk, NY

(21) Appl. No.: 10/016,935

(22) Filed: Dec. 14, 2001

(51) Int. Cl. G06F 15/16

(52) U.S. Cl. 709/206

(57) ABSTRACT

Provided are methods, data processing systems and computer programs enabling selection of an appropriate message filtering policy for inter-broker communications within a message broker network. The policy determines whether a broker should forward messages to all its neighbour brokers (‘broadcast’) or should filter messages based on subscription information for connected brokers and, if filtering, what filtering rules to implement and when. Filtering rules may differentiate between different groups of message topics. The filtering policy selected may differ for different links within a single broker or multi-broker network and, additionally or alternatively, the communication strategy for the network or for specific links within the network may be changed according to current network use characteristics.

### CROSS-REFERENCE TO RELATED APPLICATIONS

The present patent application is related to commonly assigned, co-pending patent application U.S. Ser. No. ______ (attorney reference GB9-2001-074) which is incorporated herein by reference.

### FIELD OF INVENTION

The present invention relates to communication within a data processing network and, in particular, to enabling selection of an appropriate communication strategy for message brokers or publish/subscribe communication managers and to enabling multiple communication strategies to be used for inter-broker communications within a network.

### BACKGROUND

Within a message delivery system, messages may be delivered through a network of servers including one or more “brokers” which provide routing and formatting services. The brokers are located at communication hubs within the network.

Many message brokers support the publish/subscribe communication paradigm. This involves a set of one or more publishers sending communications to a set of one or more subscribers who have registered their interest in receiving communications of that type. Publish/subscribe allows subscribing users to receive the very latest information in an area of interest (for example, stock prices or events such as news flashes or store specials). A typical publish/subscribe environment has a number of publisher applications sending messages via a broker to a number (potentially a very large number) of subscriber applications located on remote computers across the network. In this case, the subscribers-notify the broker(s) of the message types they wish to receive and this information is stored at the broker. Publishers send their messages to the broker, which compares the message type (for example, checking message header topic fields and/or checking message content) with its stored subscriber information to determine which subscribers the message should be forwarded to. The message broker may perform additional functions, such as filtering, formatting or otherwise processing received messages before forwarding them to subscribers.

In a multi-broker environment in which messages are propagated between brokers in a network, some mechanism is required for forwarding publications from a receiving broker to other brokers and eventually to subscribers. Current solutions have implemented one of the following two communication strategies for inter-broker communications:

Broadcast—in which every message received by a broker within the broker network is forwarded to all of its neighbour brokers, such that messages reach all connected brokers. Each broker checks its subscription list and forwards any matching messages to its relevant subscribers.

Proxy subscriptions—in which brokers register with each of their neighbour brokers both their own local subscriptions and proxy subscriptions received from a neighbouring broker. Now each individual broker is able to determine which messages should be sent to which of its neighbour brokers for forwarding to other brokers or subscribers, the proxy subscriptions being used to filter out messages which are of no interest to subscribers who connect via a particular neighbour broker.

Broadcasting has the disadvantage that messages are sent to brokers which have no subscribers for the message (i.e. neither any directly connected subscribers nor subscribers which connect via neighbour brokers). This results in redundant message processing, but avoids the need for brokers to communicate subscription information to other brokers. Broadcast message delivery between brokers is considered most suitable where messages are relatively cheap to process and where there is a high client turnover (i.e. frequent subscribe and unsubscribe requests).

The strategy of filtering messages using proxy subscriptions has the advantage that redundant messages are not propagated to brokers which do not require them, and this can be a significant saving if messages are expensive to process. However, the proxy subscription approach has the disadvantage of the requirement to manage the subscriptions between brokers, such that processing of subscriptions is more expensive. Also, with proxy subscriptions, there is some latency between the registration of a client subscription and the propagation of proxy subscriptions throughout the network. This means that publications sent to distant brokers after the subscription request is processed locally may not reach the local subscriber, or that some mechanism is required to ensure that they do.

Attempts to address this latter problem include that disclosed in U.S. Pat. No. 6,154,781, in which a subscriber is only notified of completion of processing its subscription after the subscription data has been propagated to other brokers, and that disclosed in IBM Corporation's Research Disclosure article 41982 of March 1999 in which brokers have a start mode which ensures that subscriptions and topological information are exchanged before publications are processed. Both of these approaches give greater certainty for publishers and subscribers regarding which messages they will receive, but do not remove the latency and may increase processing delays.

Thus, there remain problems associated with inter-broker communications whichever of the known communications strategies is used.

Message communications often have an associated “quality of service” which determines the manner in which the brokers process the message. Known quality of service characteristics include factors such as network bandwidth requirements, throughput, latency, error rate, compression, encryption, or the amount of memory or buffer space required for a data flow. Currently, typical message brokers communicate with each other using a single transport mechanism. This mechanism may not have the most desirable behaviour for all qualities of service, with the result that many messages are not processed in the most efficient manner. Broker software may implement higher qualities of service than that provided by the communication mechanism itself, but this is typically complicated and can result in systems which are difficult to administer. The alternative is to always use a transport mechanism which supports the highest qualities of service, but this incurs overheads when processing messages which only require lower qualities of service such that many messages are not handled in the most efficient manner.

U.S. Pat. No. 5,537,417 discloses a socket structure for a multiprotocol environment which moves the decision on which protocol to use for communication until the time that the connection is actually made between nodes in the network. This is an alternative to a socket having a single associated protocol which is fixed at the time the socket structure is created. A single protocol is used for all communications via the connection.

U.S. Pat. No. 5,995,503 discloses a system in which routers within a network calculate a communication path through the network which can satisfy a quality of service request. The calculations are performed based on information about available link resources and resource reservations for the network nodes. U.S. Pat. No. 5,995,503 discloses identifying an acceptable network path and avoiding links which have inadequate resources, but there is no disclosure of route or protocol selection to achieve improved efficiency when a high quality of service is not required.

IBM Corporation's book “IBM Lakes—An Architecture for Collaborative Networking”, R. Morgan Publishing, UK, 1994, describes a framework for real-time multimedia communications. Chapter 1 “Architecture fundamentals” includes a disclosure of communication end point applications exchanging information about their quality of service requirements. The Lakes components then select different network paths (link types and channels) and allocate resources according to the specified quality of service requirements, enabling multimedia applications to exchange multimedia data for effective collaborative working. Although Lakes provided invaluable support for collaborative multimedia applications, it was not applicable to communications between message brokers in a publish/subscribe environment (see below) in which endpoint applications typically have no dedicated end-to-end connection.

U.S. Pat. No. 6,101,545 discloses a message handling system in which a sender can specify a message delivery type to designate whether a message is delivery critical or time critical. A message delivery selector then selects a protocol (for example, TCP or UDP) based on the message delivery type. Thus, the sender of a message can specify a message delivery type which is analyzed and used to control selection of a message transport protocol, but no information about the intended recipient of the message is involved in this selection. In a message broker environment, any attempt to implement a solution based on U.S. Pat. No. 6,101,545 would result in many messages still being processed inefficiently because a high quality of service specified by a sender will be honoured even if not required by the recipient.

Thus, there is also a need for a more efficient solution for message broker networks, which avoids the current compromise between either satisfying quality of service requirements or achieving efficient message processing.

### SUMMARY OF INVENTION

The present invention provides methods, data processing systems and computer programs enabling selection of an appropriate communication strategy for inter-broker communication links within a message broker network. A ‘communication strategy’ in this context is the policy regarding whether a broker should forward messages to all its neighbour brokers (‘broadcast’) or should filter messages based on subscription information for connected brokers and, if filtering, what filtering rules to implement and when. The filtering policy selected may differ for different links within a single broker or multi-broker network and, additionally or alternatively, the communication strategy for the network or for specific links within the network may be changed according to current network use characteristics. The filtering policies for different links may be determined according to the communication protocol of the link. The filtering rules may differentiate between different groups of message topics.

Preferably, a pair of brokers is able to determine which communication strategy they will use for passing published messages between them, such that they can optimize use of their processing resources and the communication link between them. In the context of a link between a pair of message brokers, a ‘broadcast’ strategy means that no filtering rules are to be applied to determine which messages should be sent across that link. More generally a ‘broadcast’ strategy for messages sent from a broker means sending the messages to all neighbour brokers without filtering to identify which messages should be included in and excluded from onward transmission.

The selection of a communication filtering policy may be performed dynamically such that optimization is maintained when network characteristics change. For example, the selection may be based on client turnover statistics, message processing time, the volume of redundant messages, or other statistics. Alternatively, the communication strategy could be administratively defined for each link—but nevertheless employing a selection of an optimal strategy for the individual inter-broker communication link. The negotiation or selection of a communication strategy may result in a different communication strategy being used for each direction of traffic over a single connection.

The most simple broker networks, such as are well known in the art, are homogeneous such that a single communication strategy has been considered acceptable for the entire network. However, recent increases of integration between systems, processes and enterprises in heterogeneous data processing networks introduce the possibility of highly complex networks with a variety of publisher and subscriber characteristics. A single strategy implemented across the network may be acceptable in some parts of the network but inefficient in other parts. The present invention allows a broker network to make use of the different advantages of the different communication strategies while minimizing their disadvantages, by enabling use of the most appropriate strategy for each link between brokers, or for each communication direction for each link.

When a pair of brokers is provided with multiple communication links between them, different communication strategies may be used for each of the links and for each direction of communication, taking account of the characteristics of the particular links and the types of messages sent via those links. For example, a pair of message brokers may be interconnected by one or more TCP/IP links and one or more links which implement a transactional messaging protocol. Broadcast messaging (i.e. no filtering) may be appropriate when the TCP/IP link is being used, whereas a check of proxy subscriptions may be justified before incurring the message processing cost of transactional messaging.

The determination of which filtering policy is appropriate for inter-broker communications may result in different policies being selected for different types of message (e.g. different topic groups).

In a first aspect, the invention provides a method of configuring a message brokering system for efficient inter-broker communications in a multi-broker publish/subscribe environment in which publishers publish messages via message brokers and subscribers register with message brokers to receive published messages, the method comprising: determining at least one communication characteristic for a communication link between the message brokering system and another message brokering system; and selecting a message filtering policy according to the determined communication characteristic, for controlling the transmission of messages via the communication link. Messages are then transmitted in accordance with the selected filtering policy—for example selecting a broadcast strategy if the determination of a communication characteristic involves determining that the link uses a non-transactional communication protocol.

In a second aspect, the invention provides a message brokering system for providing a publish/subscribe service for publisher and subscriber application programs, comprising: means for receiving published messages from one or more publisher application programs; means for forwarding received messages to connected message brokers; means, responsive to at least one communication characteristic of an inter-broker communication link between the message brokering system and a connected message broker, for selecting a message filtering policy which is appropriate for the at least one communication characteristic; and means for controlling the transmission of messages via the inter-broker communication link using the selected message filtering policy.

In a third aspect, the invention provides a data processing system comprising: at least a first and a second message broker, connected via one or more inter-broker communication links and configured to provide a publish/subscribe service for publisher and subscriber application programs; means, responsive to at least one communication characteristic of a communication link between the first and second message brokers, for selecting a message filtering policy which is appropriate for the at least one communication characteristic; and means for controlling the transmission of messages via the inter-broker communication link using the selected message filtering policy.

In one embodiment of the present invention, there is provided a method of communication in a publish/subscribe environment in which publisher application programs send messages to subscriber application programs via message brokers. The brokers are able to send messages to each other using a number of different communication protocols and to apply different filtering policies. The method comprises: storing a definition of a message filtering policy for inter-broker communications for each of said communication protocols, the filtering policy either specifying no filtering or specifying a filtering rule; responsive to receipt of a published message at a first message broker, referring to characteristics of the received message to determine an appropriate inter-broker communication protocol; selecting the determined protocol and, if the selected protocol's stored message filtering policy requires application of a filtering rule, applying the filtering rule to the message; and transmitting the message to a second broker using the selected communication protocol only if transmission is consistent with the filtering rule.

This method can be used for communicating between a first message broker and a second message broker of a multi-broker network. In one embodiment, information relating to the quality of service requirements of the second message broker's registered subscriber applications is passed to the first broker. This may comprise aggregate (maximum) quality of service requirements for the second broker's subscribers. It may also include aggregate quality of service requirements for other brokers which connect to the network via the second broker. This information is then used by the first broker, together with the characteristics of received messages, to determine which protocol to use for communication between itself and the second broker. A filtering policy defined for the selected protocol is then applied to determine which messages should be sent to which brokers (either sending all messages without filtering-out any messages, or applying proxy-subscription information to filter-out messages which are not required by the set of subscribers reached via a particular broker).

In preferred embodiments of the invention, brokers notify their connected brokers about the status of their connections to other brokers in the network and/or the status of those brokers (active or failed) and/or which registered subscribers are currently connected. This information can be used to determine which subset of brokers and subscribers is currently accessible via which links. This in turn can determine which subscriber requirements are currently applicable for selecting routes, protocols and communication strategies.

A preferred embodiment of the present invention enables persistent and non-persistent messages, for example, to be sent using different communication protocols, under the control of different transport mechanisms. For example, a TCP/IP link may be used for non-persistent messages whereas a communication link providing a transactional messaging protocol may be used for messages flagged as persistent and any other messages sent to the broker under transactional scope. The transactional messaging protocol may be provided by Message-Oriented Middleware (MOM) products such as IBM's MQSeries products. A different filtering policy may be applied to each of these links.

The invention may be implemented as a computer program product, comprising program code recorded on a machine readable recording medium (such as optical or magnetic media), for controlling the operation of a data processing apparatus on which the program code executes.

### BRIEF DESCRIPTION OF DRAWINGS

Preferred embodiments of the invention will now be described in more detail, by way of example, with reference to the accompanying drawings in which:

FIG. 1 is a schematic representation of a messaging network in which publisher and subscriber applications communicate via message brokers, and in which the present invention may be implemented; and

FIG. 2 is a schematic message flow representation of processing components within a pair of message brokering systems implementing an embodiment of the present invention.

### DETAILED DESCRIPTION OF PREFERRED EMBODIMENTS

The ability to rapidly adopt, integrate and extend new and existing data processing technologies has become essential to the success of many businesses. Heterogeneity and change in data processing networks has become the norm, requiring communication solutions which achieve interoperability between the different systems. Application-to-application messaging via intelligent middleware products provides a solution to this problem.

The present invention provides significant advantages in a publish/subscribe messaging environment, balancing the apparently conflicting requirements for efficient processing of messages and efficient processing of subscriptions within a heterogeneous network. In some cases, a ‘broadcast’ communication strategy will be advantageous for inter-broker communications within a multi-broker network—accepting the overhead of sending messages to brokers which do not require them (because their registered subscribers do not wish to receive them). In other cases a proxy subscription strategy will be preferred—accepting the overhead of managing the exchange of subscription information between brokers so that the brokers can use this to reduce redundant message flows.

The invention according to a preferred embodiment of the invention also enables balancing of the requirements for reliable delivery of messages and optimised messaging performance, by enabling a message broker to consider subscriber-specified quality of service requirements as well as message characteristics and consequently to select an appropriate communication protocol for sending each message.

The publish/subscribe paradigm was described earlier. Before describing embodiments of the present invention in more detail, a brief description of message queuing and message brokers will be helpful.

Messaging and Message Brokers

IBM Corporation's MQSeries and WebSphere MQ family of messaging products are examples of known products which support interoperation between application programs running on different systems in a distributed heterogeneous environment. Message queuing and commercially available message queuing products are described in “Messaging and Queuing Using the MQI”, B. Blakeley, H. Harris & R. Lewis, McGraw-Hill, 1994, and in the following publications which are available from IBM Corporation: “An Introduction to Messaging and Queuing” (IBM Document number GC33-0805-00) and “MQSeries—Message Queue Interface Technical Reference” (IBM Document number SC33-0850-01). The network via which the computers communicate using message queuing may be the Internet, an intranet, or any computer network. IBM, WebSphere and MQSeries are trademarks of IBM Corporation.

IBM's MQSeries messaging products provide transactional messaging support, synchronising messages within logical units of work in accordance with a messaging protocol which gives assured once and once-only message delivery even in the event of system or communications failures. MQSeries products provide assured delivery by not finally deleting a message from storage on a sender system until it is confirmed as safely stored by a receiver system, and by use of sophisticated recovery facilities. Prior to commitment of transfer of the message upon confirmation of successful storage, both the deletion of the message from storage at the sender system and insertion into storage at the receiver system are kept ‘in doubt’ and can be backed out atomically in the event of a failure. This message transmission protocol and the associated transactional concepts and recovery facilities are described in international patent application WO 95/10805 and U.S. Pat. No. 5,465,328.

The message queuing inter-program communication support provided by the MQSeries products enables each application program to send messages to the input queue of any other target application program and each target application can asynchronously take these messages from its input queue for processing. This achieves delivery of messages between application programs which may be spread across a distributed heterogeneous computer network, without requiring a dedicated logical end-to-end connection between the application programs, but there can be great complexity in the map of possible interconnections between the application programs.

This complexity can be greatly simplified by including within the network architecture a communications hub to which other systems connect, instead of having direct connections between all systems. Message brokering capabilities can then be provided at the communications hub to provide intelligent message routing and integration of applications. Message brokering functions typically include the ability to route messages intelligently according to business rules and knowledge of different application programs' information requirements, using message ‘topic’ information contained in message headers, and the ability to transform message formats using knowledge of the message format requirements of target applications or systems to reconcile differences between systems and applications.

Such brokering capabilities are provided, for example, by IBM Corporation's MQSeries Integrator and WebSphere MQ Integrator products, providing intelligent routing and transformation services for messages which are exchanged between application programs using IBM's MQSeries and WebSphere MQ messaging products. Of course, such message broker capabilities could be integrated within other components of a data processing system, such as within the operating system software.

A multi-broker topology may be used to distribute load across processes, machines and geographical locations. When there are a very large number of clients, it can be particularly beneficial to distribute those clients across several brokers to reduce the resource requirements of the brokers, and to reduce the impact of a particular server failing. The scalability and failure tolerance of such multi-broker solutions enable messages to be delivered with acceptable performance when there is a high message throughput or a broker fails. When clients are geographically separated, it can be beneficial to have brokers located local to groups of clients so that the links between the geographical locations are consolidated, and for well designed topic trees this can result in many messages not having to be sent to remote locations.

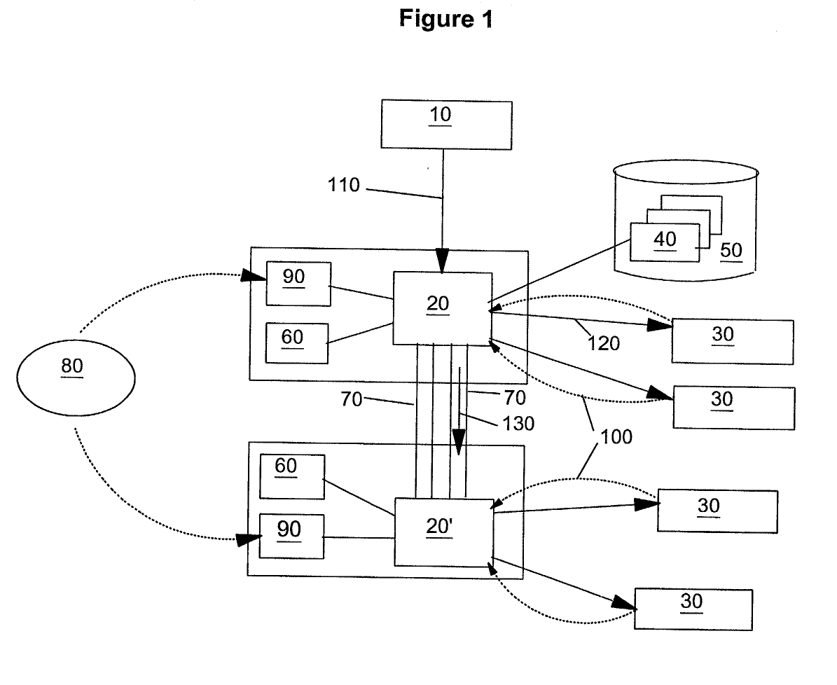

FIG. 1 shows an example message broker network in which one or many publisher applications 10 are sending 110 messages to a first message broker 20. The first message broker may have one or many subscriber applications 30 which have registered 100 their interest in receiving specified message types from the publishers. In a typical publish/subscribe message broker environment, the publisher does not explicitly identify target subscribers and may not know or care who the subscribers are. Publisher and subscriber applications do not have a dedicated end-to-end connection, and may not even be concurrently connected to the broker network.

Instead, publishers typically specify 110 topic names for the messages they are publishing, and subscribers specify 100 topic names for the messages they are interested in receiving. The message broker includes a matching engine which compares an incoming message with the subscription profiles 40 of the various subscribers to identify matches, and passes matching messages to an output component for forwarding to the relevant subscribers. For example, a subscriber S1 may be interested in receiving all messages related to the IBM stock price and may send a subscription request to the broker such as “Stock/IBM”. The broker stores this subscription information. Then if a message arrives at the broker from a publisher and the message header includes topic identifiers “Stock/IBM” the broker will compare this message with its subscription lists, identify that the message matches the subscription profile for subscriber S1 and route the message to S1.

Other message broker solutions enable content-based routing of messages (i.e. the analysis of a message by the broker is not limited to the topic information in message headers). For a topic such as “Stock/IBM”, a content filter “Body.price>100” could also be used to only identify a match for published messages in which the stock price exceeds the specified value.

Whatever method is used to determine appropriate message routing, conventional message broker solutions use the same transport mechanism for all messages. For example, a message broker within IBM's MQSeries Integrator product could be configured to always send messages with transactional assured delivery under the control of IBM's MQSeries message delivery software. In this example, the message transport mechanism is able to satisfy publisher-specified requirements for transactional message delivery, which may be vital for some applications. However, there may be types of messages or sets of subscribers for which transactional message delivery is unnecessary, and in that case it would be beneficial to enable use of a low-overhead transport mechanism which is optimised for efficiency instead of delivery assurance. Some alternative publish/subscribe solutions always use a low-overhead delivery mechanism, which is efficient for non-persistent messages but fails to meet the important requirement of some applications for assured once-only message delivery under transactional scope.

Protocol Selection and Inter-Broker Filtering Policy

The present invention can be implemented within a multi-broker network to provide the flexibility for selection of an appropriate protocol and filtering policy for each link and even each message transmission between message brokers. For persistent messages which are sent to a first message broker under transactional scope, it is likely that the delivery assurance features of a transaction-oriented messaging product will be required. Unless the broker's quality of service policy dictates otherwise (see below), messages which arrive under transactional scope will be sent onwards by the broker under transactional control. However, for non-persistent or non-transactional messages, it may be that delivery assurance is either not wanted at all or is only wanted if it can be achieved with a specified level of messaging performance. Known message brokers typically do not take sufficient account of the conflict between efficiency and delivery assurance, or the different factors that can influence which filtering policy achieves optimum efficiency.

The invention enables a pair of brokers or the set of brokers in a broker network to select an appropriate filtering policy for communication of messages between them. In some cases, the most efficient communication strategy will be to broadcast all published messages to all brokers without consideration of the target brokers' subscriber requirements (i.e. not attempting to filter-out redundant messages). Then each broker in the network receives all messages and compares them with subscription information for its local subscribers to identify a match. In other cases, it will be more efficient for the brokers to communicate their respective subscription requirements to each other and for the brokers to examine these requirements to determine which messages to send on to which other brokers. The optimal communication strategy may differ for different pairs of brokers within the network, and even for different directions of communication across a specific link between the pair of brokers.

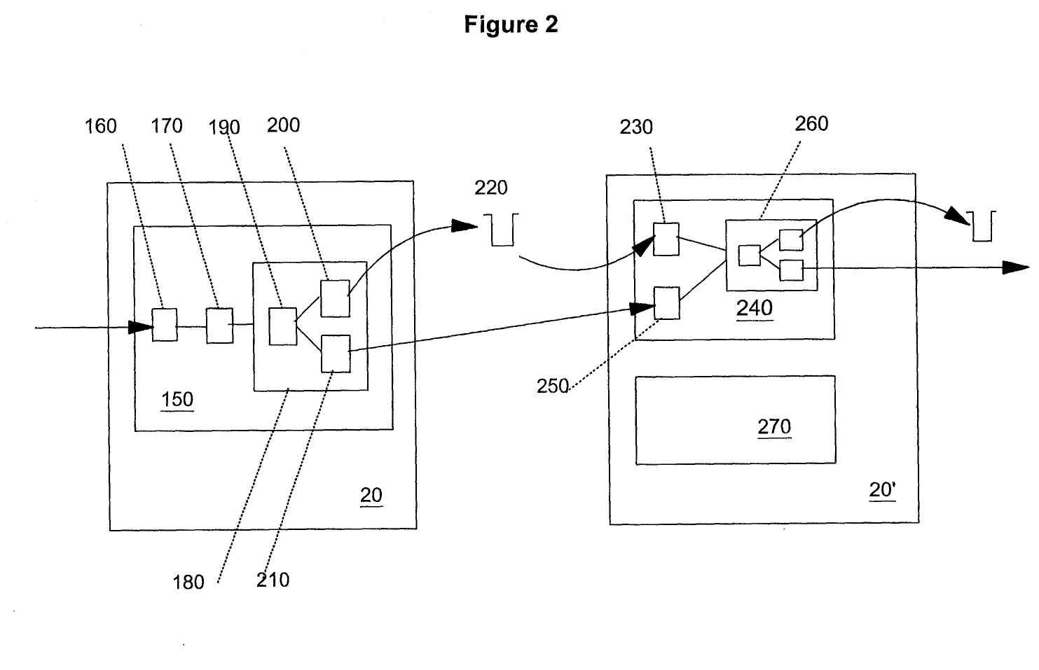

An implementation of a message broker according to the invention, and its operation within a multi-broker network, will now be described in more detail with reference to FIGS. 1 and 2.

Referring to FIG. 1, publishers 10 create messages containing a topic name. The publisher either specifies a required quality of service explicitly or the message characteristics enable an appropriate transport mechanism and quality of service to be identified implicitly. The published messages are delivered 110 to a connected message broker 20 via the identified transport mechanism. Subscribers 30 create subscriptions 40 containing a topic attribute and, optionally, a requested quality of service attribute or content filter for that topic. These subscriptions are registered 100 with the message broker, which stores them in a table format in a repository 50. The table includes quality of service requirements and filters for each topic of interest for each of the subscribers 30 that connect to the broker network via connections to that broker 20. A single subscriber 30 may register multiple subscriptions 40 with different requested qualities of service and filters for different topics.

Each broker 20 includes a process for generating aggregate information for the subscriber quality of service requirements within its table, and for sending this aggregate requirement information to its connected message brokers 20′. On receipt of this information, the brokers update their own tables to include the aggregate requirement information for all nearest neighbour connected brokers. Thus, each broker 20 knows the maximum quality of service requirements for each of its network links, including links to a connected subscriber 30 and links 70 to another message broker 20′.

Each message broker contains one or more connection managers 60 which keeps the broker informed of the status of each of its connections 70 to the other message brokers. This information can be used by the broker for route selection, but in particular can be combined with the aggregate quality of service requirement information to determine which of the currently available connections can be used to satisfy specified quality of service requirements and which specified quality of service requirements are relevant to the currently connected set of brokers and subscribers. Additional information on further downstream connections and/or subscription state may also be passed to the brokers for further filtering of which subset of quality of service requirements are applicable to the current set of connected brokers and subscribers.

Administrators define quality of service policies 80 for message communication for particular subscribers and particular topics, including rules for determining the quality of service requirements and hence the transport mechanisms and protocols which may be used for each message. These policies are input to a configuration manager 90 associated with the broker. Rules which merely define a required quality of service for a message type or message topic are known in the art, but a significant feature of the quality of service policies implemented here is the ability to override or reduce a requested quality of service when appropriate for the current set of connected brokers and subscribers.

When a message broker 20 receives a published message, it scans its subscription tables 40 to identify the set of subscriptions which match the topic in the message, and looks up other attributes of the message which can be used to determine appropriate message processing. As noted earlier, subscriptions may contain a filtering expression on elements of the message body.

For each subscriber 30 having a registered subscription 40 which matches the message, the message 25 broker 20 determines a delivery quality of service based on the following:

the quality of service with which the message was delivered to the broker, or attributes of the message;

the quality of service attribute of the matching subscription(s); and

the administrator-defined policy 80 for the message topic and the subscriber which registered the subscription.

For each nearest-neighbour message broker 20′, the current message broker 20 determines a delivery quality of service based on:

the quality of service with which the message was delivered to the broker, or attributes of the message;

the aggregate quality of service requirements stored for the nearest neighbour broker 20′;

the administrator-defined policy for the topic; and

the status of connections to the nearest neighbour broker.

Subject to the inter-broker communication strategy relating to filtering of messages based on proxy subscriptions (described below), the message broker delivers 120, 130 the message to each subscriber or connected message broker with the determined quality of service. Where the broker has multiple active connections to the subscriber or connected message broker, the most appropriate connection 70 for the required quality of service is selected to deliver the message, based on the policy for the topic.

Example quality of service attributes for subscriptions (including message persistence) and example topic-related quality of service policies are described in commonly assigned copending patent application U.S. Ser. No. ______ (attorney reference GB9-2001-0074) which is incorporated herein by reference. For messages received at a broker, different communication paths are used for onward transmission of the received messages to differentiate between different transaction modes of the received messages, the requirements of relevant subscribers, and the quality of service policy for the broker. The transaction modes determine whether each instance of message processing via the broker is under transaction control.

To avoid the effect on performance of treating all messages received from an adjacent broker node as transactional (even though transactional delivery is not always required), separate communication paths are provided between nodes of the messaging system for transmission of messages of differing transaction modes. Thus, the sender would direct messages using the route that applies to the transaction mode of the message. The receiver of non-transactional messages is not required to treat the message in a transactional way, which allows the best performance for non-transactional messages.

For an implementation where the processing nodes of the messaging system are message brokers, and the inter-broker communication employs message queues, the sending broker would direct messages to one of a number of separate queues on the adjacent broker based on the available transaction modes of the message. The receiving broker would read messages from the non-transactional queue without the need to start a new transaction for each. A number of different connections are established between each pair of connected brokers—for example one TCP connection and one or more connections which use the transactional message queueing delivery capabilities of a message oriented middleware product such as IBM's MQSeries or WebSphere MQ products. Messages can be enqueued onto a queue associated with a respective one of those connections, for transfer to a neighbour message broker, after selecting a protocol based on a message's quality of service requirements.

Inter-Broker Filtering Policy

The above description focussed mainly on the protocols and communication links to be used for transferring messages from a broker to a connected broker or subscriber. Also described above is the possibility of applying a different message filtering policy for inter-broker communications based on the characteristics of the link and/or current communication characteristics. This will now be described in more detail. Selection and application of different message filtering policies can be implemented independent of any quality of service and protocol selection, but it is also possible for a single solution to provide the capability for protocol selection and for selection of an appropriate filtering policy for inter-broker communications.

According to a first implementation, a filtering policy is selected for an inter-broker communication link as a step of establishing the link. Firstly, a communication characteristic is defined for the link (such as when establishing a TCP link, the protocol is a characteristic of the link). Secondly, this characteristic is compared with a list of administrator-defined associations (or rules defining relationships) between communication characteristics and message filtering policies, to select a message filtering policy for the communication link. An identification of this selected policy is then stored in association with the communication link.

In this example implementation, unfiltered or ‘broadcast’ messaging is implemented for all inter-broker transmissions of published messages for which a TCP/IP connection is used. The principle here is that the low cost message transfer generally does not justify the cost of reducing message flows by checking proxy subscriptions and applying filtering. However, for all published messages which are to be sent from a first broker to a neighbouring broker via a transactional messaging protocol under control of a messaging manager, proxy subscriptions are referenced and used to filter out any messages which do not need to be sent to this neighbour broker. In this implementation, the choice between broadcast and proxy-subscription policies is administratively defined for each link between neighbouring message brokers. In this example, the broadcast strategy for TCP/IP messaging is implemented as a static definition for all TCP links. However, the proxy subscription filtering policy is dynamically modifiable according to network communication characteristics.

In particular, the message brokers can be configured to switch their filtering policy for transactional messaging to a broadcast policy for inter-broker messaging whenever network communication characteristics show that this would be more efficient than filtering based on proxy-subscriptions. For example, if a broker or pair of brokers are required to make changes to their subscription tables more frequently than a defined threshold (for example, if the processing performed by this pair of brokers is affected by more than 10 subscribe and unsubscribe requests per second) then it may be considered more efficient to switch to broadcast messaging between those brokers than to implement filtering based on proxy subscriptions. This check of subscribe/unsubscribe frequency can take account of the location within the network of the relevant subscribers and hence be applied to only one direction of communication across a communication link if the frequency of subscription changes is not uniform across the network.

When the subscribe/unsubscribe activity drops back below a threshold, transactional messaging may revert back to the default use of filtering in accordance with proxy subscriptions.

In an alternative implementation, if broadcast message delivery is being implemented between a pair of brokers and message delivery delays are unacceptable due to the number of messages being sent (including redundant messages), brokers may be able to increase efficiency by applying filtering rules to reduce the number of transmitted messages. This requires an assessment of the cause of message delivery delays (i.e. whether the limitation on message throughput is the bandwidth of the available links or the processing being performed at the broker before sending messages).

When a dynamic policy is used, then a message broker may make one of two decisions. Firstly, based on the characteristics of the set of messages being sent to it by a connected message broker, a message broker may decide that the current filtering policy being used by the connected message broker is inappropriate. In this case the message broker sends an indication to the connected message broker, informing it that it should change its policy with respect to the message broker.

For example: publications sent from BrokerA to BrokerB are currently ‘broadcast’ (unfiltered), but BrokerB is receiving a large number of messages and is discarding most of them due to there being no appropriate subscribers. BrokerB sends a message to BrokerA indicating that the policy should be changed to one of message filtering based on proxy subscriptions. In addition, this message contains all the required proxy subscriptions so that the change can be made without losing any messages.

Secondly, based on the characteristics of the set of proxy subscriptions being sent to it by a connected message broker, a message broker may decide that the current policy it is using to send messages to a connected message broker is inappropriate. In this case the message broker changes its policy and sends an indication to the connected message broker, informing it that its policy has been changed.

For example, BrokerA is sending published messages to BrokerB and is currently using a proxy-subscription-based filtering, but BrokerA is spending far too much of its time processing proxy messages from BrokerB. BrokerA sends a message to BrokerB informing it that henceforth BrokerA will broadcast messages to BrokerB, and that BrokerB should stop sending proxy messages to BrokerA. BrokerA uses the maximum quality of service requirement for the current set of proxy subscriptions for all subsequent publications sent to BrokerB. BrokerA can discard all proxy subscriptions immediately. If the maximum quality of service requirements in BrokerB change, BrokerB sends a message to BrokerA requesting the new quality of service.

These examples show that there is considerable flexibility within the scope of the present invention regarding whether filtering policies and specific filtering rules should be fixed or dynamically alterable and how they should be implemented.

Despite some links between brokers having an administrator-defined, fixed broadcast communication strategy, some subscription information may still be exchanged between the brokers. This may include information regarding the maximum required quality of service, for use in protocol selection. When using a link which provides a transactional messaging protocol, the exchanged subscription information is used for determination of both the appropriate communication protocol (and consequent selection of a link) and for message filtering. However, if there are no subscribers connected to this part of the broker network which require persistent message delivery and a broadcast inter-broker communication strategy has been defined by an administrator for non-transactional messaging, then it is possible to avoid exchanging subscriber information between some brokers.

In a second implementation, the type of filtering policy applied to inter-broker messaging may differ for different message types—for example varying the policy for different message topics. One example implementation allows a broadcast policy to be specified for one group of topics whereas other groups of topics use proxy subscriptions. This may be implemented such that proxy-subscription-based filtering is applied to all message topics other than specified topics such as “stock/#” (where # is a wildcard which matches anything) and broadcast is used for the specified topics. This will generally be administrator-defined, but could also be dynamically-determined with reference to the number of redundant messages sent between brokers for different message topics (e.g. measured in relation to a threshold percentage of total). A topic-specific determination of the filtering policy may also enable the administrator to ensure that messages on certain topics will only be sent in one direction across an inter-broker link.

As noted above, when a link from BrokerA to BrokerB is defined as broadcast for a range of topics, this may result in BrokerB ceasing sending any proxy subscription information to BrokerA for the range of topics. However, this result would mean that BrokerA cannot send full proxy subscription information to any of its other neighbours for this topic range. Therefore BrokerA would then be obliged to request that all of its neighbours send messages to it via broadcast for this range of topics, so that BrokerA receives the messages it will broadcast to BrokerB. These neighbours would then also request broadcast from their other neighbour brokers. Thus, if the decision to set a link to use the broadcast strategy implies that no proxy subscription information will be sent to neighbour brokers, then any broadcast link will have a broadcast ‘tree’ behind it. An exception to this is that brokers within a multi-broker collective will each send their subscription details to the other members of the collective—and having done that they are not obliged to request broadcast links from the other members of their collective or to forward proxy subscription information from one member of the collective to other members.

Hence, for solutions in which selection of a broadcast strategy for an inter-broker communication link implies that no proxy subscription information will be sent across that link, a particularly advantageous filtering policy selection rule is that the tree of all upstream links from a broadcast link that would normally be used for forwarding proxy subscription information will also be broadcast, because that tree will stop receiving proxy subscriptions. For message brokers implementing this selection rule, when a link from a broker is set to be broadcast, or when a neighbour requests the link to be broadcast, then for consistent operation the broker also requests that all links from other brokers to which it would normally forward proxy subscriptions from the link are also broadcast.

Message Flows

The message brokers implement a sequence of processing steps on received messages using messageflows. These are sequences of processing components corresponding to paths though a message broker's program code (visually representable as a graphical sequence of processing ‘nodes’), which start and end with input and output nodes. The input nodes are responsible for receiving messages from particular queues or reading messages from particular IP connections (or for receiving messages in any other way, for example by accessing shared memory, or by retrieving a file as input). The output nodes are responsible for sending messages to required destinations—either via queues, IP connections, or other transports. Message transfer between brokers results from a neighbour destination being specified with attributes which indicate which transport is required, which may be an IP connection, a queue being handled transactionally, a queue being handled non-transactionally or another mechanism. The message flows implement rule-based message processing and filtering, with a single message flow being made up of an input node, and output node and one or more processing nodes such as a matching node, a filter or a computation node.

A publisher node is one of the processing nodes which can be deployed in a message broker's message flow. Publisher nodes are a complex node including a matching node (for comparing a received message with subscription information to identify matching subscribers), and at least one output node for forwarding the message to the matching subscribers.

Message flows are created using a visual programming technology to support broker capabilities such as publish/subscribe message delivery, message transformation, database integration, message warehousing and message routing, and which greatly ease the task of management and development of message brokering solutions. A message flow represents the sequence of operations performed by the processing logic of a message broker as a directed graph (a message flow diagram) between an input queue and a target queue. The message flow diagram consists of message processing nodes, which are representations of processing components, and message flow connectors between the nodes. Message processing nodes are predefined components, each performing a specific type of processing on an input message. The processing undertaken by these nodes may cover a range of activities, including reformatting of a message, transformation of a message (e.g. adding, deleting, or updating fields), routing of a message, archiving a message into a message warehouse, or merging of database information into the message content. There are two basic types of message processing nodes: endpoints and generic processing nodes. Endpoints represent points in the message flow to which message producers may send messages (input nodes) or from which message consumers may receive messages (output nodes). Endpoints are associated with system queues and client applications interact with an endpoint by reading from or writing to these queues. Generic processing nodes take a message as input and transform it into zero, one, or more output messages. Each such message processing node has a set of InTerminals through which it receives messages, and a set (possibly empty) of OutTerminals, through which it propagates the processed message. Message processing nodes have properties which can be customized. These properties include expressions that are used by the processing node to perform it's processing on input messages.

A message flow is created by a visual programmer using visual programming features of the message broker. This involves placing message processing nodes on a drawing surface, and connecting the out terminal of one node to the in terminal of another node. These connections determine the flow of the messages through the message processing nodes. A message flow can contain a compound message processing node which is itself a message flow. In this way message flows can be built modularly, and specific message processing functionality can be reused.

Message flows are executed by an execution engine that can read a description of a message flow, and invoke the appropriate runtime code for each message processing node. This will be referred to later. Each message flow has a thread pool which can be configured to have between 1 and 256 threads. When an input node for a message flow is constructed it takes one thread from its thread pool and uses it to listen to the input queue. A single thread carries a message from the beginning of the flow through to the end, and hence the thread can be used to identify the message as it passes through the flow.

The queuing of an input message on that input queue initiates execution of the message flow on the queued message. The message is then propagated to the target nodes of the connectors originating from the output terminal of the input node. If there is more than one outgoing connector, copies of the message are created and handled independently by the subsequent nodes. If the node is an output node, the message is delivered to the associated message queue; otherwise the processing node will create zero or more output messages for each of its output terminals. Messages are propagated to subsequent nodes as described above.

A message processing node will process an input message as soon as it arrives and retain no information about the message when it has finished its processing. A processing node might output more than one message of the same type through an output terminal and several copies of the same message might be propagated if there is more than one connector originating from an output terminal; all of these messages are processed independently of each other. A processing node does not necessarily produce output messages for all of its output terminals—often it will produce one output for a specific terminal depending on the specific input message. Also, a node might produce messages for output terminals that are not connected to other processing nodes, in which case the message is not processed further.

As shown in FIG. 2, a message broker 20 implementing the present invention in a multi-broker environment includes a first message flow 150 which is within the message brokering system's user space. This message flow includes an input node 160, a processing node 170 (e.g. a formatter), and a publisher node 180. The publisher node is made up of matcher 190 and two output nodes 200, 210.

The matcher 190 checks received messages against the subscription information 40 held in a repository 50 (as shown in FIG. 1) to identify matching subscribers, and routes the message to one or other of the output nodes 200, 210 according to whether the message is to be forwarded by transactional store-and-forward messaging or via TCP/IP communications. The first output node 200 receives messages determined to require transactional messaging, and implements a put operation to place the message in a message queue 220. The message will either be retrieved directly from this queue by local subscriber application programs or will be transferred to a message queue which is accessible by subscriber application programs. Subject to proxy-subscription filtering, the message will also be transferred from queue 220 to an input node 230 of a neighbouring message broker 20′. The example message flow 240 in this case is internal to the broker 20′ (i.e. not in user space) and its role is limited to the distribution of messages between brokers and subscribers. It includes an input node for transactional store-and-forward messaging 230, an input node 250 for TCP/IP messaging, and a publisher node 260 which includes a matcher and two output nodes. This broker 20′ will typically also include one or more user-space message flows 270.

The second output node 210 sends messages via a TCP connection to an input node 250 of each neighbour message broker 20′. No proxy-subscription-based filtering is performed prior to sending the TCP messages, such that the communication strategy is to broadcast to all connected brokers.

Thus, two or more inter-broker communication links are established between neighbour brokers. A message filtering policy can be selected for each link, in accordance with either the link itself, the communication protocol to be used for communication across the link, or the message topic.

Specifying a filtering policy by the parameters (Link, protocol, topic, policy), examples are:

(all, all, #, filtered)—all topics:

This defines the default policy for all topics to be filtered. This is overridden by the rules for more specific topics.

(all, all, stock/quote/#, broadcast)—stock quotes:

These messages are known to be small, and it is expected that most brokers will usually have subscriptions to most of the topics.

(all, all, admin/alert/#, filtered)—administrator alert messages:

These messages are intended for a small audience which does not change. There is no point in broadcasting them.

(all, all, stock/trade/#, dynamic)—stock trades:

We can't predict the volumes or locations of these messages, so we leave the determination of which policy to use to be dynamic. The dynamic policy can be implemented either by a rule defined by code within the broker, or may be itself administratively defined by a rule.

(A->B, all, department/personnel/#, none)—personnel update messages

These messages are intended for an audience in a particular part of the network, and we don't want them passed over this link (and hence to the rest of the network) at all.

An example of a rule used for dynamic determination is:

downstream (publications from this broker to other broker):

if

%processing time for subscription requests > 25%
total processing time, or
%topics covered by proxy subscriptions > 80% of
total topics,

then

broadcast

else

filtered

upstream (publications from other broker to this broker):

if

%processing time for redundant messages > 25% total
processing time, or
latency (time for message sent from other broker to
this broker) > 500ms

then

filtered

else

broadcast

Alernatively, the inter-broker communication policy may be statically determined in response to a protocol selection, and consistent for all message topics. So using parameters (Link, protocol, topic, policy) again, an advantageous example is:

(all, TCP/IP, #, broadcast)

(all, TransMQ, #, filtered)

where TransMQ means use of a persistent, transactional messaging protocol

It will be understood by persons skilled in the art, that various modifications may be made to the methods, message brokers and messaging systems described above within the scope of the present invention. For example, the above described embodiment involved each message broker sending aggregate subscriber requirement information to its connected brokers such that each message broker can take account of those requirements for the next ‘hop’ of a message from a broker to a connected neighbour broker. An alternative embodiment is for aggregate requirements to be propagated throughout the network, such that each broker knows the maximum quality of service requirements for any subscriber which is contactable via each of its network links, including subscribers which are only reachable by multiple intermediary systems (multiple ‘hops’ across the network). Another embodiment builds a database containing quality of service requirements for all subscribers, with each broker having access to that database and holding network topology information for determining a complete network route from the current broker to each registered subscriber in the network.

Another implementation of the present invention takes account of subscriber license terms or network management characteristics to predict the optimal filtering policy for each network link, instead of measuring dynamic network traffic characteristics. That is, instead of measuring characteristics such as subscribe/unsubscribe frequency or message redundancy statistics, the brokers may be configured to differentiate between brokers based on the ability or inability of individual subscribers to change their subscriptions, or based on whether their subscription charges provide any motivation to change. For example, it may be predicted that subscribe/unsubscribe requests will be rare if subscribers have their subscriptions set for them by an administrator based on users' job responsibilities rather than users' personal choice, especially if the individuals are not personally accountable for their subscription charges. In another example, if subscription is an expensive service (either in terms of per-hour subscription costs or in terms of message processing) then a user may need to subscribe and unsubscribe regularly according to when they need to receive published messages and which topics they are interested in at a particular time. In such cases, a different filtering policy may be predicted to be suitable for the different categories of subscriber and hence for different brokers within the network.

What is claimed is:

1. A message brokering system for providing a publish/subscribe service for publisher and subscriber application programs, comprising:
means for receiving published messages from one or more publisher application programs;
means for forwarding received messages to connected message brokering systems;
means, responsive to a communication characteristic of an inter-broker communication link between the message brokering system and one of said connected message brokering systems, for selecting a message filtering policy which is appropriate for the communication characteristic; and
means for controlling the forwarding of messages via the inter-broker communication link using the selected message filtering policy.

2. A message brokering system according to claim 1, wherein the communication characteristic used to select a message filtering policy is a communication protocol provided by the communication link.

3. A message brokering system according to claim 1, wherein establishing an inter-broker communication link includes:
defining the communication characteristic for the link;
comparing the communication characteristic with a list of administrator-defined associations between communication characteristics and message filtering policies, to select a message filtering policy for the communication link; and
storing an identification of the selected message filtering policy in association with the communication link.

4. A message brokering system according to claim 1, wherein the communication characteristic used to select a message filtering policy includes a dynamic communication characteristic.

5. A message brokering system according to claim 4, wherein the communication characteristic used to select a message filtering policy includes a measure of subscription activity.

6. A message brokering system according to claim 4, wherein the communication characteristic used to select a message filtering policy includes a measure of redundant message transmissions.

7. A message brokering system according to claim 1, wherein the means for controlling includes means for implementing a broadcast messaging policy and means for implementing a proxy-subscription-based message filtering policy, a respective one of said means for implementing being activated in response to said selection of a message filtering policy.

8. A message brokering system according to claim 7, wherein said means for implementing a proxy-subscription-based messaging policy comprises:
means for receiving subscription information for connected message brokering systems and for storing said subscription information for comparison with received published messages;
means for forwarding to connected message brokering systems subscription information for subscriber application programs connected to the message brokering system.

9. A message brokering system according to claim 7, wherein the broadcast messaging policy is implemented for links which provide a non-transactional messaging protocol and the proxy-subscription-based message filtering policy is implemented for links which provide a transactional messaging protocol.

10. A message brokering system according to claim 1, wherein the selection of a message filtering policy is specific to a selected message topic or topic group.

11. A data processing system comprising:
at least a first and a second message broker, connected via one or more inter-broker communication links and configured to provide a publish/subscribe service for publisher and subscriber application programs;
means, responsive to a communication characteristic of a communication link between the first and second message brokers, for selecting a message filtering policy which is appropriate for the communication characteristic; and
means for controlling the transmission of messages via the inter-broker communication link using the selected message filtering policy.

12. A data processing system according to claim 11, wherein said means for selecting a message filtering policy is adapted to select one of a plurality of different policies in response to characteristics of a received message.

13. A data processing system according to claim 12, wherein the means for selecting a message filtering policy is adapted to select one of a plurality of different policies in response to a topic identifier within a received message.

14. A computer program product for providing a publish/subscribe brokering service for publisher and subscriber application programs, comprising program code recorded on a machine-readable recording medium, the program code comprising:
means for receiving published messages from one or more publisher application programs;
means for forwarding received messages to connected message brokering systems;
means, responsive to a communication characteristic of an inter-broker communication link between the message brokering system and one of said connected message brokering systems, for selecting a message filtering policy which is appropriate for the communication characteristic; and
means for controlling the forwarding of messages via the inter-broker communication link using the selected message filtering policy.

15. A method of communication in a publish/subscribe environment in which publisher application programs send messages to subscriber application programs via message brokers. The brokers are able to send messages to each other using a number of different communication protocols and to apply different filtering policies. The method comprises:
storing a definition of a message filtering policy for inter-broker communications for each of said communication protocols, the filtering policy either specifying no filtering or specifying a filtering rule;
responsive to receipt of a published message at a first message broker, referring to characteristics of the received message to determine an appropriate inter-broker communication protocol;
selecting the determined protocol and, if the selected protocol's stored message filtering policy requires application of a filtering rule, applying the filtering rule to the message; and
transmitting the message to a second broker using the selected communication protocol only if transmission is consistent with the filtering rule.

16. A method of configuring a message brokering system for efficient inter-broker communications in a multi-broker publish/subscribe environment in which publishers publish messages via message brokers and subscribers register with message brokers to receive published messages, the method comprising:
responsive to a communication characteristic for a communication link between the message brokering system and another message brokering system, selecting a message filtering policy according to the determined communication characteristic; and
controlling the transmission of messages via the communication link using the selected message filtering policy.
